(19) United States
(12) Patent Application Publication
(10) Pub. No.: US 2024/0174179 A1
(43) Pub. Date: May 30, 2024

(54) DISPLAY CONTROL APPARATUS, IMAGE PICKUP APPARATUS, MOVABLE APPARATUS, AND STORAGE MEDIUM

(71) Applicant: CANON KABUSHIKI KAISHA, Tokyo (JP)

(72) Inventors: JUN KAWATA, Kanagawa (JP); YASUHIRO KOJIMA, Tokyo (JP)

(21) Appl. No.: 18/497,263

(22) Filed: Oct. 30, 2023

(30) Foreign Application Priority Data
Nov. 29, 2022 (JP) 2022-190102

(51) Int. Cl. B60R 1/28

(52) U.S. Cl. CPC B60R 1/28; B60R 2300/105; B60R 2300/303; B60R 2300/802

(57) ABSTRACT

A display control apparatus is configured to control a display unit configured to display information about a surrounding area of an user's vehicle. The display control apparatus includes a memory storing instructions, and a processor configured to execute the instructions to select a partial area from an imaging area of an imaging unit configured to image the surrounding area, cut a cutout image corresponding to the partial area from an image captured by the imaging unit, and cause the display unit to display the cutout image and a first range indicating a position of the partial area relative to the user's vehicle.

### BACKGROUND

### Technical Field

One of the aspects of the embodiments relates to a display control apparatus, an image pickup apparatus, a movable apparatus, and a storage medium.

### Description of Related Art

A configuration for displaying an image around the user's vehicle captured by an in-vehicle (on-board) camera on a display device has been conventionally proposed (see Japanese Patent Laid-Open No. 2020-88606).

In a case where the in-vehicle camera has a wide-angle lens, the above configuration can acquire an image of a wide range, but an information amount increases and the user's (driver's) recognition deteriorates and it is necessary to cut and display a part of the image. However, in a case where the angle of view is changed, the user cannot recognize which range of the image he is viewing relative to the user's vehicle. Japanese Patent Laid-Open No. 2020-88606 discloses that an icon indicating that the imaging area of the camera is changed according to a mode is displayed on the display device, but this reference is silent about a configuration that allows the user to recognize which range of the image in the imaging area he is viewing.

### SUMMARY

A display control apparatus according to one aspect of the embodiment is configured to control a display unit configured to display information about a surrounding area of an user's vehicle. The display control apparatus includes a memory storing instructions, and a processor configured to execute the instructions to select a partial area from an imaging area of an imaging unit configured to image the surrounding area, cut a cutout image corresponding to the partial area from an image captured by the imaging unit, and cause the display unit to display the cutout image and a first range indicating a position of the partial area relative to the user's vehicle. An image pickup apparatus and an movable apparatus each having the above display control apparatus also constitute another aspect of the embodiment. A display control method corresponding to the above display control apparatus also constitutes another aspect of the embodiment. A storage medium storing a program that causes a computer to execute the above display control method also constitutes another aspect of the embodiment.

Further features of the disclosure will become apparent from the following description of embodiments with reference to the attached drawings.

### BRIEF DESCRIPTION OF THE DRAWINGS

FIG. 1 illustrates an automobile as an example of a movable unit according to this embodiment.

FIG. 2 illustrates the configuration of the automobile as the example of the movable unit according to this embodiment.

FIGS. 3A and 3B explain an imaging optical system in an in-vehicle camera.

FIGS. 4A and 4B explain an operation of a display control apparatus according to a first embodiment.

FIGS. 5A and 5B illustrate an example of the content displayed on a display surface of a display device according to the first embodiment

FIGS. 6A, 6B, and 6C illustrate examples of icons displayed on the display surface of the display device according to the first embodiment.

FIG. 7 illustrates an example of an icon displayed on the display surface of the display device of the first embodiment.

FIG. 8 is a flowchart illustrating the operation of the display control apparatus according to the first embodiment.

FIG. 9 explains an operation of a display control apparatus according to a second embodiment.

FIG. 10 illustrates an example of the content displayed on a display surface of a display device according to the second embodiment.

FIG. 11 explains an operation of a display control apparatus according to a third embodiment.

FIGS. 12A and 12B illustrate an example of the content displayed on a display surface of a display device according to the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

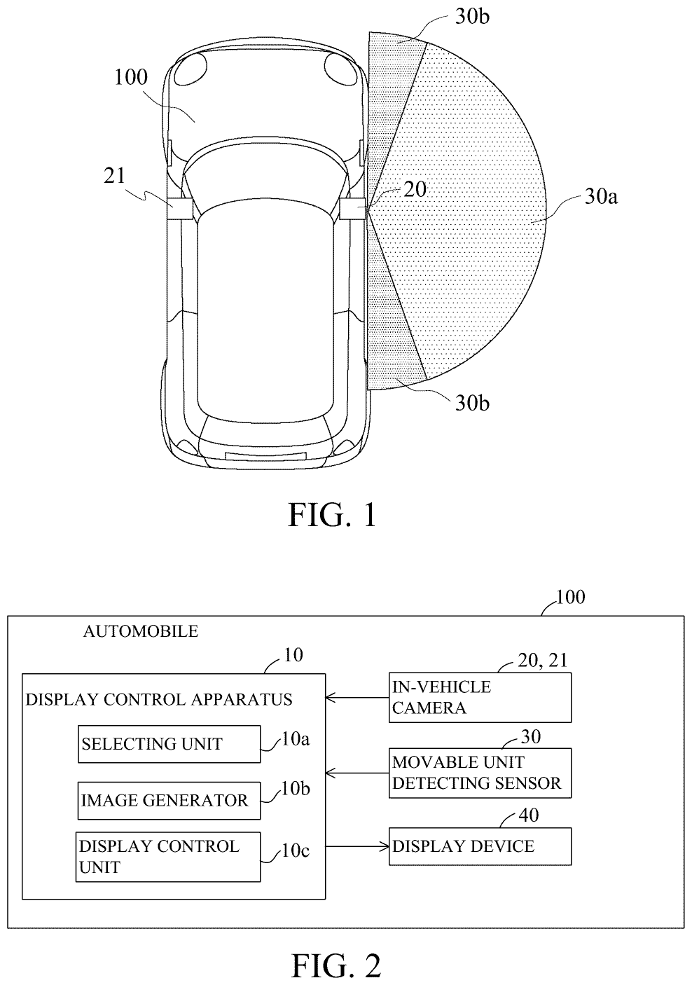

FIG. 1 illustrates an automobile (user's vehicle or host vehicle: simply referred to as a vehicle hereinafter) which is an example of a movable unit (movable apparatus) having an imaging unit according to this embodiment. As illustrated in FIG. 1, the vehicle 100 includes in-vehicle (on-board) cameras (imaging units) 20 and 21 that are side cameras configured to image the surroundings of the vehicle 100. In this embodiment, the in-vehicle camera (first imaging unit) 20 images a right surrounding area of the vehicle 100, and the in-vehicle camera 21 (second imaging unit) captures a left surrounding area of the vehicle 100. The in-vehicle cameras 20 and 21 have the same configurations, and the imaging area (entire angle of view) will be described using the in-vehicle camera 20 as an example.

The in-vehicle camera 20 has an imaging range with an angle of view of about 180 degrees in this embodiment. The imaging range of the in-vehicle camera 20 is divided into imaging ranges 30a and 30b. In particular, the imaging ranges 30b schematically illustrate areas where high-resolution images can be obtained due to the characteristics of the optical system of the in-vehicle camera 20. As illustrated in FIG. 1, the in-vehicle camera 20 as a side camera can acquire images of the imaging range 30b as the surrounding area of the viewing angle distant from the optical axis at the center of the viewing angle with the resolution higher than that of an image of the imaging range 30a. Therefore, the in-vehicle cameras 20 and 21 can acquire high-resolution images of the left and right rear of the vehicle 100 to be confirmed using the door mirrors. The captured images are displayed on a display device 40 provided in the vehicle 100, and the driver (user) of the vehicle 100 can check the left and right and left and right rear by checking the displayed images.

While the in-vehicle cameras 20 and 21 are provided so as to image the left and right surrounding areas of the vehicle 100 in this embodiment, the embodiment is not limited to this example. The in-vehicle cameras 20 and 21 may be provided, for example, so as to image the front and rear surrounding areas of the vehicle 100.

FIG. 2 illustrates the configuration of vehicle 100. The vehicle 100 includes a display control apparatus 10, in-vehicle cameras 20 and 21, a movable unit detecting sensor (detector) 30, and a display device (display unit) 40. Although the display control apparatus 10 and the display device 40 are separate from each other in this embodiment, they may be integrated with each other. The display control apparatus 10 may be mounted on the in-vehicle cameras 20 and 21.

Each of the in-vehicle cameras 20 and 21 includes an imaging optical system and an image sensor configured to capture an image formed by the imaging optical system, and moves together with the vehicle 100 to image the surrounding areas of the vehicle 100. Each of the in-vehicle cameras 20 and 21 transmits a captured image to the display control apparatus 10. This embodiment uses a wide-angle lens as the imaging optical system. The wide-angle lens will be described below.

The movable unit detecting sensor 30 is configured to detect a movable unit such as automobiles and motorcycles. The movable unit detecting sensor 30 transmits the detection result to the display control apparatus 10.

The display device 40 is a display unit configured to display information about the surrounding area of the vehicle 100. The display device 40 is, for example, a liquid crystal display or an organic EL display. The information about the surrounding area of the vehicle 100 includes, for example, images captured by the in-vehicle cameras 20 and 21 and information about the movable unit detected by the movable unit detecting sensor 30. In this embodiment, the display device 40 includes a display device (first display unit) configured to display information about the right surrounding area of the vehicle 100 and a display device (second display unit) configured to display information about the left surrounding area of the vehicle 100. Although the display device 40 displays information about the left and right surrounding areas of the vehicle 100 in this embodiment, this embodiment is not limited to this example. The display device 40 may display, for example, information about the front and rear surrounding areas of the vehicle 100.

The display control apparatus 10 includes a computer, such as an Electronic Control Unit (ECU) including at least one processor and memory. The display control apparatus 10 includes a selecting unit 10a, an image generator 10b, and a display control unit 10c, and controls the display device 40. The selecting unit 10a selects a selected area as a partial area (angle of view) from the imaging areas of the in-vehicle cameras 20 and 21. The image generator 10b cuts out a cutout image (clipped image) corresponding to the selected area selected by the selecting unit 10a from the images captured by the in-vehicle cameras 20 and 21. The display control unit 10c causes the display device 40 to display the cutout image and a cutout range (first range) indicating the position of the selected area relative to the vehicle 100. The wide-angle lens that is used as the imaging optical system can provide a wide-range image, but the wide-range image contains a large amount of information, which deteriorates the user's recognition. In addition, in a case where the angle of view is changed, the user cannot recognize which range of the image he is viewing relative to the vehicle 100. Accordingly, in this embodiment, the image generator 10b causes the display device 40 to display the cutout images cut out of the images captured by the in-vehicle cameras 20 and 21, thereby improving the user's recognition. In addition, by causing the display device 40 to display the cutout range indicating the position of the selected area relative to the vehicle 100, the user can recognize which range of the image he is viewing relative to the vehicle 100.

In this embodiment, in a case where the movable unit detecting sensor 30 detects a movable unit (first movable unit) approaching the vehicle 100 in an area outside the selected area, the display control unit 10c causes the display device 40 to display information indicating the approach of the movable unit. For example, the display control unit 10c changes the display (a part of the cutout range or an area near the cutout range) on the side of the cutout range in which the movable unit 202 approaches the vehicle 100. Thereby, the user can recognize the movable unit approaching from the outside of the angle of view.

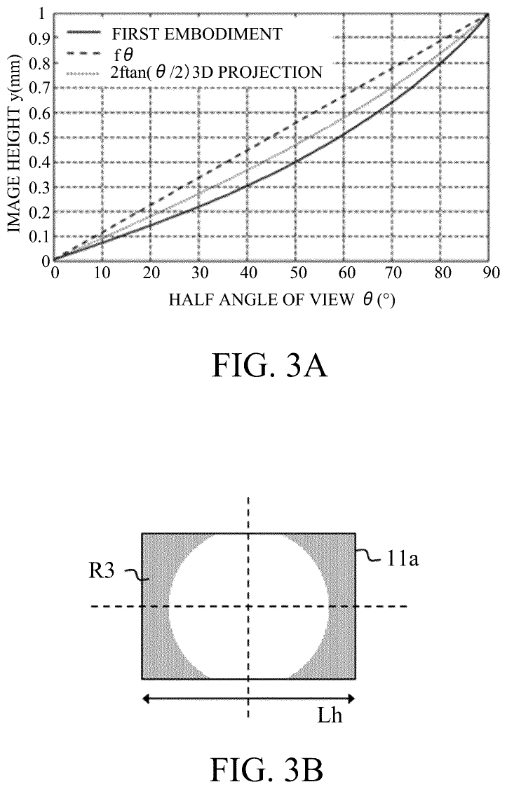

Referring now to FIGS. 3A and 3B, a description will be given of the imaging optical system provided in each the in-vehicle cameras 20 and 21. Although the characteristics of the imaging optical systems provided by the in-vehicle cameras 20 and 21 may not necessarily be the same, in this embodiment, the imaging optical systems provided by the in-vehicle cameras 20 and 21 have substantially the same characteristics. The imaging optical system provided to the in-vehicle camera 20 will be used as an example.

FIG. 3A explains the optical characteristic of the imaging optical system in the in-vehicle camera 20, and illustrates a projection characteristic y(θ) representing a relationship between an imaging height (image height) y and a half angle of view (an angle between the optical axis and the incident light beam) θ on the imaging surface (image plane) of the image sensor in the in-vehicle camera 20. In FIG. 3A, a horizontal axis represents a half angle of view θ, and a vertical axis represents an image height y.

As illustrated in FIG. 3A, the imaging optical system in the in-vehicle camera 20 has different resolutions depending on the areas as an increasing amount in the image height y relative to a unit amount of the half angle of view θ. The local resolution is represented by a differential value dy(θ)/dθ of the projection characteristic y(θ) at the half angle of view θ. That is, the larger the slope of the projection characteristic y(θ) in FIG. 3A is, the higher the resolution is.

In this embodiment, each of the in-vehicle cameras 20 and 21 includes the imaging optical system having the projection characteristic y(θ) that satisfies the following inequality (1). In the imaging optical system, a central area corresponds to the imaging range 30a, and an outer area having a half angle of view θ equal to or greater than a predetermined half angle of view θa corresponds to the imaging range 30b. This imaging optical system may be called a reverse different angle of view lens.

0.20<2×f×tan(θmax/2)/y(θmax)<0.95 (1)

where f is a focal length of the imaging optical system, and θmax is a maximum half angle of view of the imaging optical system.

The in-vehicle cameras 20 and 21 may satisfy the inequalities (2) and (3) about the surrounding area of the imaging surface of the image sensor:

0.35Lh≤Lb≤0.5Lh (2)

0.35Lh≤Lf≤0.5Lh (3)

where Lb is a distance between the image position on the imaging plane of the object behind the vehicle 100 and the center of the imaging plane, Lf is a distance between the image position on the imaging plane of the object in front of the vehicle 100 and the center of the imaging plane, and Lh is a length of a side extending in a direction in which the two image positions are separated from each other on the imaging plane.

Inequalities (2) and (3) define conditions for effectively using the most surrounding area R3 on the imaging plane 11a, as illustrated in FIG. 3B. In a case where inequalities (2) and (3) are not satisfied, the most surrounding area R3 cannot be captured with the high-resolution, and it becomes difficult to acquire detailed information from the captured image. In other words, satisfying inequalities (2) and (3) can provide high-resolution imaging of the most surrounding area R3. By cutting the high-resolution partial image acquired from the most surrounding area R3 and outputting it to the display device 40 for display, the driver can obtain detailed information ahead and behind. However, in a case where a low-resolution partial image that is not in the most surrounding area R3 is cut out and output to the display device 40 for display, the driver can at least recognize whether or not an object exists in the optical axis direction.

In this embodiment, each of the in-vehicle cameras 20 and 21 has the above configuration, and is therefore installed on the vehicle 100 so that the front and rear of the vehicle 100 can be imaged by the most surrounding area R3. For example, the optical axes of the in-vehicle cameras 20 and 21 are set to the sides of the vehicle 100 and substantially parallel to the ground (horizontal plane), and the most surrounding area R3 can be an imagable angle of the front and rear of the vehicle 100.

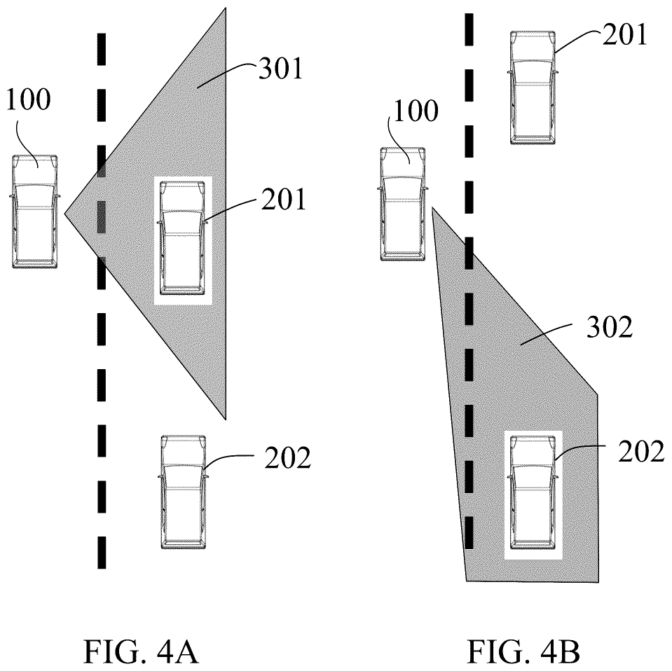

The operation of the display control apparatus 10 will be described below. FIGS. 4A and 4B explain the operation of the display control apparatus 10. In this embodiment, the selecting unit 10a selects a selected area from the imaging areas based on the detection result of the movable unit detecting sensor 30. More specifically, the selecting unit 10a acquires information about one of movable units approaching the vehicle 100, which is closest to the vehicle 100, from the movable unit detecting sensor 30. Next, the selecting unit 10a selects the selected area so that the cutout image includes one of the movable units approaching the vehicle 100, which is closest to the vehicle 100. This embodiment assumes two lanes (two lanes on one side), but this embodiment is applicable to a single lane, and three or more lanes.

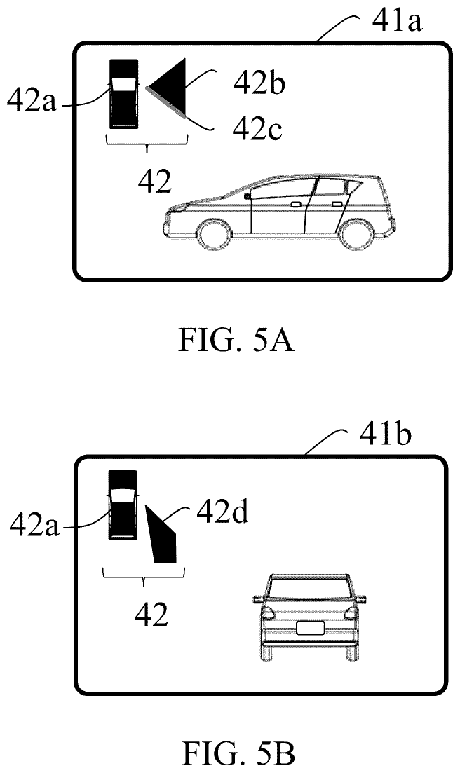

FIG. 4A illustrates movable units (vehicles) 201 and 202 are approaching the driving vehicle 100. In FIG. 4A, the movable unit 201 is the closest vehicle to the vehicle 100, and the movable unit 202 is the second closest vehicle to the vehicle 100 after the movable unit 201. In the situation of FIG. 4A, the selecting unit 10a acquires the detection result from the movable unit detecting sensor 30. The detection result is, for example, that the movable units 201 and 202 are approaching the driving vehicle 100, that the movable unit 201 is the closest vehicle to the vehicle 100, and that the movable unit 202 is the second closest vehicle to the vehicle 100 after the movable unit 201. The selecting unit 10a selects a selected area 301 from the imaging area of the in-vehicle camera 20 so that the cutout image includes the movable unit 201 closest to the vehicle 100. The image generator 10b cuts a cutout image corresponding to the selected area 301 and including the movable unit 201 from the image captured by the in-vehicle camera 20. The display control unit 10c causes the display device 40 to display a cutout image 41a cut out by the image generator 10b, as illustrated in FIG. 5A. The display control unit 10c causes the display device 40 to display an icon 42 including an icon 42a indicating the vehicle 100 and a cutout range 42b indicating the position of the selected area 301 relative to the vehicle 100.

The display control unit 10c changes the display on the side of the cutout range 42b in the direction in which the movable unit 202 approaches the vehicle 100 so that the user can recognize the movable unit 202 approaching from the outside of the angle of view. In this embodiment, the display control unit 10c changes the color of a portion 42c of the cutout range 42b on the side in the direction in which the movable unit 202 approaches the vehicle 100, as illustrated in FIG. 5A. The display method is not limited to this example as long as the user can recognize the movable unit 202 approaching from the outside of the angle of view. For example, the display on the side of the cutout range 42b in the direction in which the movable unit 202 approaches the vehicle 100 may be blinked, or the frame on the side of the cutout range 42b in the direction in which the movable unit 202 approaches the vehicle 100 may be made thicker.

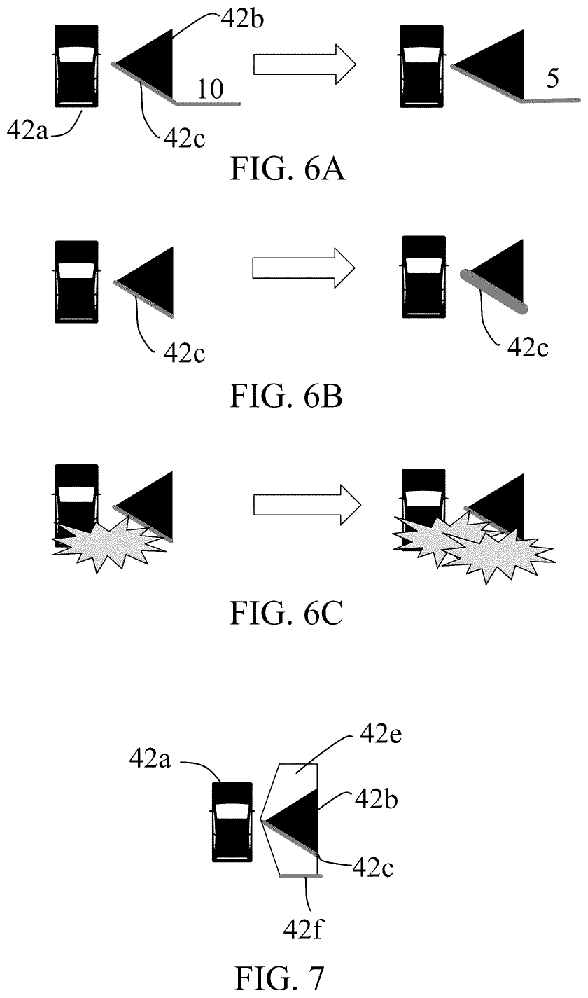

The display control unit 10c may change the display of the direction in which the movable unit 202 approaches the vehicle 100 in the cutout range 42b according to the distance between the vehicle 100 and the movable unit 202. For example, the display control unit 10c may add information about the distance between the vehicle 100 and the movable unit 202 to the icon 42, as illustrated in FIG. 6A. As illustrated in FIG. 6B, the display control unit 10c may thicken the portion 42c of the cutout range 42b in the direction in which the movable unit 202 approaches the vehicle 100 as the distance between the vehicle 100 and the movable unit 202 reduces. Furthermore, as illustrated in FIG. 6C, the display control unit 10c may shorten blinking intervals of the display on the side of the cutout range 42b in the direction in which the movable unit 202 approaches the vehicle 100 as the distance between the vehicle 100 and the movable unit 202 reduces.

The display control unit 10c may cause the icon 42 to include an imaging range (second range) 42e indicating the position of the imaging area relative to the vehicle 100, as illustrated in FIG. 7. In addition, the display control unit 10c may change the display of the direction in which the movable unit 202 approaches the vehicle 100 in the imaging range 42e. FIG. 7 changes the color of a portion 42f on the side in which the movable unit 202 in the imaging range 42e approaches the vehicle 100.

FIG. 4B illustrates that the movable unit 201 overtakes the vehicle 100 and leaves the vehicle 100, and the movable unit 202 approaches the vehicle 100 from the situation of FIG. 4A. In FIG. 4B, the movable unit 201 is the closest vehicle to the vehicle 100, and the movable unit 202 is the second closest to the vehicle 100 after the movable unit 201. In the situation of FIG. 4B, the selecting unit 10a acquires the detection result from the movable unit detecting sensor 30. The detection result is, for example, that the movable unit 201 is moving away from the vehicle 100 and the movable unit 202 is approaching the vehicle 100, or that the movable unit 201 is closest to the vehicle 100, and that the movable unit 202 is second closest to the movable unit 201. The selecting unit 10a selects a selected area 302 from the imaging area of the in-vehicle camera 20 so that the cutout image can include the movable unit 202 closest to the vehicle 100 among the movable units approaching the vehicle 100. The image generator 10b cuts a cutout image corresponding to the selected area 302 and including the movable unit 202 from the image captured by the in-vehicle camera 20. The display control unit 10c causes the display device 40 to display a cutout image 41b cut by the image generator 10b, as illustrated in FIG. 5B. At this time, the display control unit 10c causes the display device 40 to display an icon 42 including an icon 42a indicating the vehicle 100 and a cutout range 42d indicating the position of the selected area 302 relative to the vehicle 100. In the situation of FIG. 4B, since there is no movable unit approaching from the outside of the angle of view, the display control unit 10c does not cause the display device 40 to display information indicating a movable unit approaching the vehicle 100.

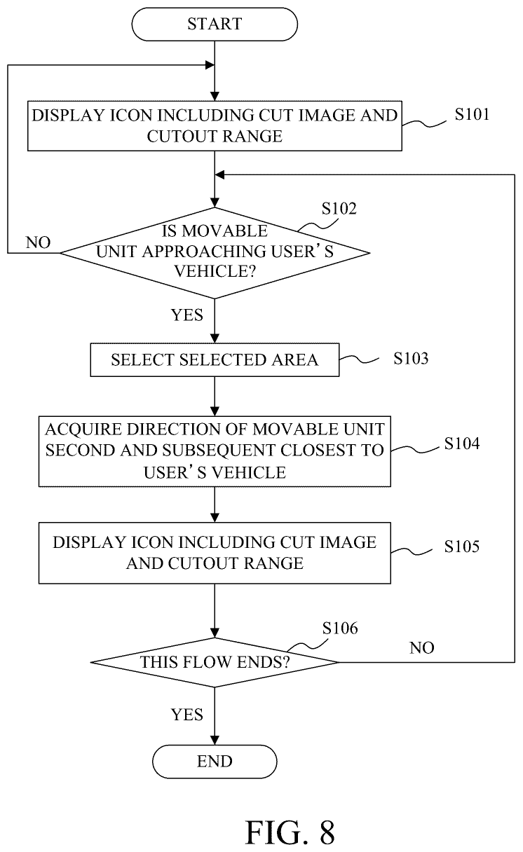

The operation flow of the display control apparatus 10 described above will be described below. FIG. 8 is a flowchart illustrating the operation of the display control apparatus 10 according to this embodiment. This flow starts when the power is supplied to the display control apparatus 10. In this embodiment, the power is supplied to the display control apparatus 10, for example, when the ignition switch (start switch) of the vehicle 100 is turned on, or when the shift lever of the vehicle 100 is changed to a position other than parking.

In step S101, the display control unit 10c causes the display device 40 to display the icon that includes a cutout image corresponding to a selected area that has been previously selected (a selected area set in the initial state) and a cutout range that indicates the position of the selected area relative to the vehicle 100.

In step S102, the display control unit 10c determines whether a movable unit is approaching the vehicle 100 from behind (rear side) the vehicle 100, using the detection result of the movable unit detecting sensor 30. In a case where the display control unit 10c determines that the movable unit is approaching the vehicle 100 from behind the vehicle 100, the processing of step S103 is executed. In a case where the display control unit 10c determines that no movable unit is approaching the vehicle 100 from behind the vehicle 100, the processing of step S101 is executed.

In step S103, the selecting unit 10a selects the selected area from the imaging area of the in-vehicle camera 20 so that the cutout image includes the movable unit closest to the vehicle 100 among the movable units approaching the vehicle 100 from behind the vehicle 100. In addition, the image generator 10b cuts a cutout image corresponding to the selected area from the image captured by the in-vehicle camera 20.

In step S104, the display control unit 10c acquires a direction of a movable unit as the second or subsequent closest vehicle among the movable units approaching the vehicle 100 from behind the vehicle 100, using the detection result of the movable unit detecting sensor 30. The acquired information is used to allow the user to recognize a movable unit approaching from the outside of the angle of view.

In step S105, the display control unit 10c causes the display device 40 to display the cutout image cut out by the image generator 10b and the icon including the cutout range indicating the position of the selected area relative to the vehicle 100.

In step S106, the display control apparatus 10 determines whether to end this flow. The display control apparatus 10 determines that this flow is to end in a case where the power supply ends or the user instructs to end the processing. In a case where the display control apparatus 10 determines to end this flow, this flow ends. In a case where the display control apparatus 10 determines not to end this flow, the processing of step S102 is executed.

As described above, the configuration according to this embodiment enables the user to recognize which range of the image he is viewing relative to his vehicle. Displaying the presence of the movable unit with an icon or the like even in the non-displayed range enables the user to recognize that the movable unit exists outside the display range.

### Second Embodiment

The first embodiment has discussed the two lanes on one side, but this embodiment will discuss three lanes on one side. An automobile (vehicle hereinafter) 100 as an example of a movable unit in this embodiment has the same configuration as that of the vehicle 100 in the first embodiment. This embodiment will discuss only a configuration different from that of the first embodiment, and will omit a description of the common configuration.

In this embodiment, the selecting unit 10a selects a selected area so that the cutout image includes one of movable units that approach the vehicle 100 and are located within a predetermined distance from the vehicle 100, which is closest to the vehicle 100. The distance from the vehicle 100 may be a distance from the center position of the vehicle 100 or a distance from the movable unit detecting sensor 30. For example, in a case where the movable unit detecting sensor 30 provided on the right side of the vehicle 100 is used as a reference, a distance from the direction toward the right side of the vehicle 100 (direction perpendicular to the traveling direction of the vehicle 100 and the gravity direction) may be set within 2 m, which is shorter than the lane width (3.5 m) This setting can restrain a selected area from being selected such that the cutout image includes a movable unit traveling in a lane distant from the lane of the vehicle 100.

A description will now be given of a case where a first movable unit is driving in a lane adjacent to a first lane of the vehicle 100 and a second movable unit is driving in a lane distant from the first lane and is closer to the vehicle 100 than the first movable unit. Both the first movable unit and the second movable unit are approaching the vehicle 100. In this case, the user would like to recognize the first movable unit driving in the lane adjacent to the first lane, rather than the second movable unit that is closer to the vehicle 100. However, the configuration according to the first embodiment selects the selected area such that the cutout image includes the second movable unit closest to the vehicle 100. On the other hand, in the configuration according to this embodiment, the movable unit must satisfy the condition that its distance from the vehicle 100 is within a predetermined range, and thus a selected area is selected such that the cutout image includes the first movable unit rather than the second movable unit closest to the vehicle 100. In other words, in a case where the movable unit closest to the vehicle 100 is a movable unit that is driving in a lane distant from the vehicle 100, a selected area is restrained from being selected so that the cutout image includes that movable unit. Thereby, the display control apparatus 10 can display a movable unit that the user is most concerned about (would like to know) among the movable units around the vehicle 100.

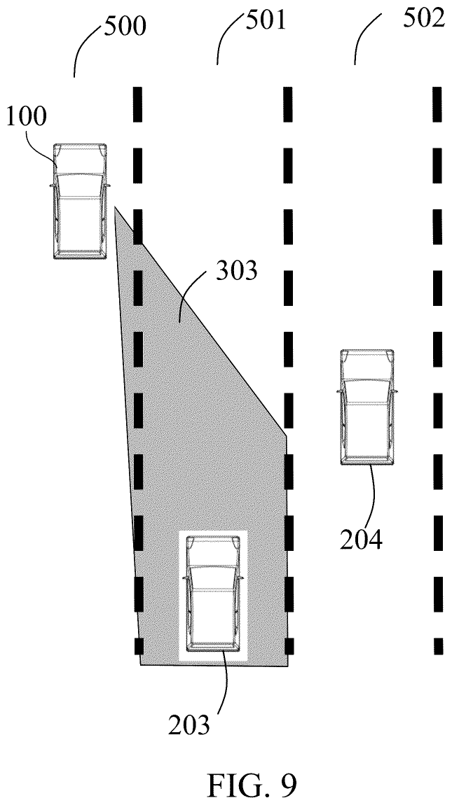

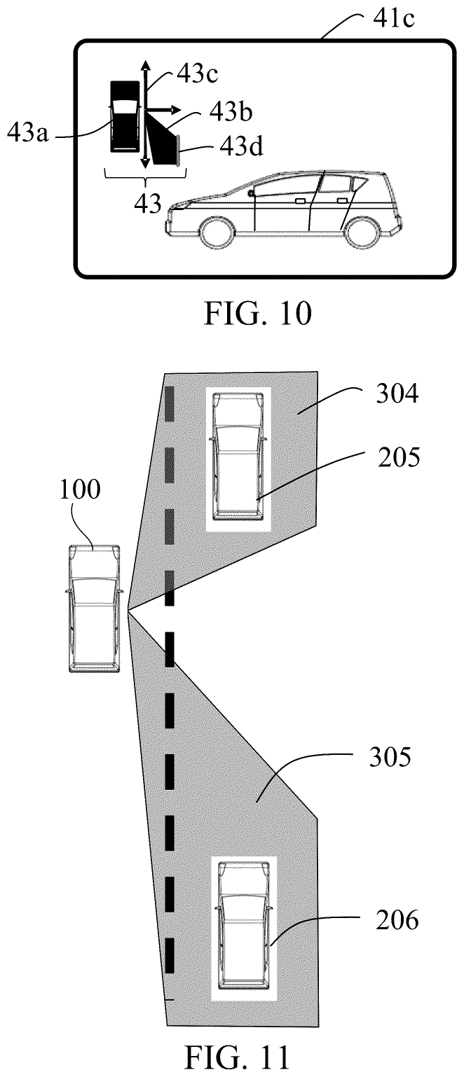

FIG. 9 explains the operation of the display control apparatus 10. In FIG. 9, the vehicle 100 and movable units 203 and 204 are traveling in lanes 500, 501, and 502, respectively. Assume that the movable unit 204 is the closest to the vehicle 100 and the movable unit 203 is the second closest to the vehicle 100 after the movable unit 204. In the situation of FIG. 9A, the selecting unit 10a selects a selected area 303 such that the cutout image includes the movable unit 203 closest to the vehicle 100 among the movable units that are approaching the vehicle 100 and are located within a predetermined distance from the vehicle 100. The predetermined range is 2 m in the direction toward the right side of the vehicle 100, 0 m in the direction toward the front side of the vehicle 100, and 20 m in the direction toward the backside of the vehicle 100. The image generator 10b cuts out a cutout image that corresponds to the selected area 303 and includes the movable unit 203 from the image captured by the in-vehicle camera 20. The display control unit 10c causes the display device 40 to display a cutout image 41c cut by the image generator 10b, as illustrated in FIG. 10. At this time, the display control unit 10c displays an icon 43 including an icon 43a indicating the vehicle 100, a cutout range 43b indicating the position of the selected area 303 relative to the vehicle 100, and an icon 43c indicating the predetermined range.

The display control unit 10c may change the display on the side of the cutout range 43b in the direction in which the movable unit 204 approaches the vehicle 100 so that the user can recognize the movable unit 204 approaching from the outside of the angle of view. In this embodiment, as illustrated in FIG. 10, the display control unit 10c changes the color of a portion 43d of the cutout range 43b in the direction in which the movable unit 204 approaches the vehicle 100.

### Third Embodiment

The first and second embodiments have discussed the case that causes a single display device to display a cutout image corresponding to one selected area and a cutout range on one side of the user's vehicle. This embodiment will discuss a case that causes a plurality of display devices to display cutout images corresponding to a plurality of selected areas and cutout ranges on one side of the user's vehicle. That is, in this embodiment, the display device 40 includes a plurality of display devices (first display units) configured to display information about the surrounding area on the right side of the vehicle 100. The display device 40 in this embodiment further includes a plurality of display devices (second display units) configured to display information about the surrounding area on the left side of the vehicle 100. The display device 40 may include a plurality of first display units and a plurality of second display units. An automobile (hereinafter, self-vehicle) 100 as an example of the movable unit in this embodiment has the same configuration as that of the vehicle 100 in the first embodiment. This embodiment will discuss only a configuration different from that of each of the first and second embodiments, and will omit a description of the common configuration.

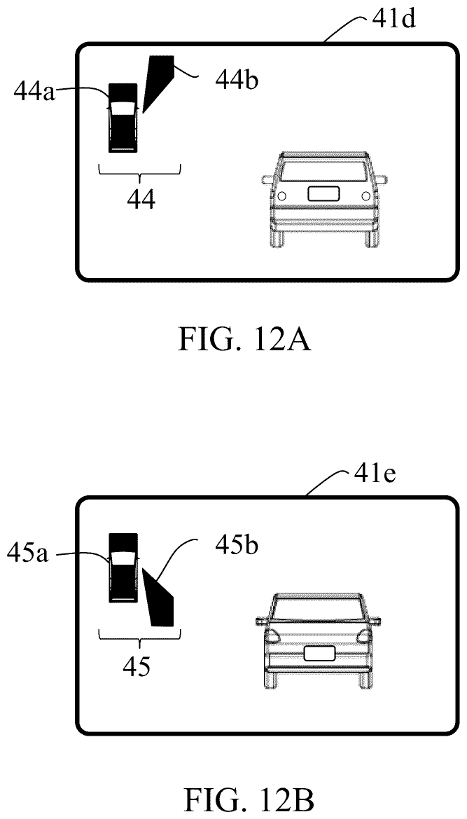

FIG. 11 explains the operation of the display control apparatus 10. In FIG. 11, a movable unit 205 is driving on the right front side of the vehicle 100, and a movable unit 206 is driving on the right rear side of the vehicle 100. In FIG. 11, assume that the movable unit 205 is the closest to the vehicle 100 and the movable unit 206 is the second closest to the vehicle 100 after the movable unit 205. In the situation of FIG. 11, the selecting unit 10a selects a selected area 304 such that a cutout image includes the movable unit 205, and selects a selected area 305 such that a cutout image includes the movable unit 206. The image generator 10b cuts a cutout image corresponding to the selected area 304 and including the movable unit 205 and a cutout image corresponding to the selected area 305 and including the movable unit 206 from the image captured by the in-vehicle camera 20. The display control unit 10c causes one of the display devices 40 to display a cutout image 41d cut by the image generator 10b, as illustrated in FIG. 12A. At this time, the display control unit 10c causes the display device 40 to display an icon 44 that includes an icon 44a indicating the vehicle 100 and a cutout range 44b indicating the position of the selected area 304 relative to the vehicle 100. In addition, as illustrated in FIG. 12B, the display control unit 10c causes the display device not displaying the cutout image 41d to display a cutout image 41e cut by the image generator 10b. At this time, the display control unit 10c causes the display device 40 to display an icon 45 that includes an icon 45a indicating the vehicle 100 and a cutout range 45b indicating the position of the selected area 305 relative to the vehicle 100.

A single display device may display all cutout images and cutout ranges. In this case, the number of display devices 40 may be one. For example, the images in FIGS. 12A and 12B are displayed on one display device.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each of the embodiments has used a wide-angle lens for each of the in-vehicle cameras 20 and 21, but each in-vehicle camera may not necessarily be a wide-angle lens. For example, three image pickup apparatuses may be used to image the front, sides, and rear of the vehicle 100, respectively.

This application claims the benefit of Japanese Patent Application No. 2022-190102, filed on Nov. 29, 2022, which is hereby incorporated by reference herein in its entirety.

What is claimed is:

1. A display control apparatus configured to control a display unit configured to display information about a surrounding area of a user's vehicle, the display control apparatus comprising:
a memory storing instructions; and
a processor configured to execute the instructions to:
select a partial area from an imaging area of an imaging unit configured to image the surrounding area,
cut a cutout image corresponding to the partial area from an image captured by the imaging unit, and
cause the display unit to display the cutout image and a first range indicating a position of the partial area relative to the user's vehicle.

2. The display control apparatus according to claim 1, wherein the processor is configured to select the partial area based on a detection result of a detector configured to detect a movable unit.

3. The display control apparatus according to claim 2, wherein the processor is configured to select the partial area so that the cutout image includes one of movable units that approach the user's vehicle, which is closest to the user's vehicle.

4. The display control apparatus according to claim 2, wherein the processor is configured to select the partial area so that the cutout image includes one of movable units that approach the user's vehicle and are located within a predetermined distance from the user's vehicle, which is closest to the user's vehicle.

5. The display control apparatus according to claim 1, the processor is configured to:
select a plurality of partial areas from the imaging area,
generate a plurality of cutout images corresponding to each of the plurality of partial areas from the image, and
cause the display unit to display the plurality of cutout images and a plurality of first ranges indicating positions of the plurality of partial areas relative to the user's vehicle.

6. The display control apparatus according to claim 1, wherein in a case where a detector configured to detect a movable unit detects a first movable unit approaching the user's vehicle in an area outside the partial area, the processor is configured to cause the display unit to display information indicating approach of the first movable unit.

7. The display control apparatus according to claim 6, wherein the processor is configured to change display on a side of a direction in which the first movable unit approaches the user's vehicle in the first range.

8. The display control apparatus according to claim 7, wherein the processor is configured to change display according to a distance between the user's vehicle and the first movable unit.

9. The display control apparatus according to claim 6, the processor is configured to change display on a side of a direction in which the first movable unit approaches the user's vehicle in a second range indicating a position of the imaging area relative to the user's vehicle.

10. An image pickup apparatus comprising:
the display control apparatus according to claim 1; and
an image sensor.

11. A movable apparatus comprising:
the display control apparatus according to claim 1;
an imaging unit configured to image a surrounding area of a user's vehicle;
a detector configured to detect a movable unit; and
a display unit configured to display information about the surrounding area.

12. The movable apparatus according to claim 11, wherein the imaging unit includes:
a first imaging unit configured to image a first surrounding area; and
a second imaging unit configured to image a second surrounding area different from the first surrounding area.

13. The movable apparatus according to claim 11, wherein the display unit includes:
a first display unit configured to display information about a first surrounding area; and
a second display unit configured to display information about a second surrounding area different from the first surrounding area.

14. A display control method configured to control a display unit configured to display information about a surrounding area of a user's vehicle, the display control method comprising the steps of:
selecting a partial area from an imaging area of an imaging unit configured to image the surrounding area,
cutting a cutout image corresponding to the partial area from an image captured by the imaging unit, and
causing the display unit to display the cutout image and a first range indicating a position of the partial area relative to the user's vehicle.

15. A non-transitory computer-readable storage medium storing a program that causes a computer to execute the display control method according to claim 14.
